(19) United States
(12) Patent Application Publication
(10) Pub. No.: US 2002/0173977 A1
(43) Pub. Date: Nov. 21, 2002

(54) Charging for a computer based on actual usage time

(75) Inventor: Rabindranath Dutta, Austin, TX (US)

Correspondence Address: Duke W. Yee, Carstens, Yee & Cahoon, LLP, P. O. Box 802334, Dallas, TX, 75380, US

(73) Assignee: International Business Machines Corporation, Armonk, NY

(21) Appl. No.: 09/859,248

(22) Filed: May 17, 2001

(51) Int. Cl. G06F 17/60

(52) U.S. Cl. 705/1

(57) ABSTRACT

A method, system and computer program product for charging, by a computer service provider, for a computer system based on usage time is provided. Responsive to receiving a request to utilize the computer system, an operational connection is established between the computer service provider and the computer system. Usage time and periodic charge rate information is received via the operational connection. A charge is then calculated for the usage of the computer system based on results of the usage time and the periodic charge rate.

### BACKGROUND OF THE INVENTION

1. Technical Field

The present invention relates to an improved data processing system, and more particularly to using an improved data processing system. Still, more particularly, the present invention improved data processing system for charging for a computer system based on actual usage time of the computer system.

2. Description of Related Art

Computers over the last quarter century have infiltrated almost every aspect of modern life. Computers are used by large corporations and universities to perform very complex functions as well as by individuals in their homes to perform a variety of functions. However, not everyone, at present may own, or may even intend to buy a computer.

There are many reasons as there are potential computer owners for this reluctance to invest in a computer. For example, some may be afraid of the technology itself, some may be intimidated by the processing power a computer may possess, some may be unfamiliar with the way a computer operates or be unfamiliar with new and exciting informational resources available to the computer owner and operator. Unfortunately, with this unwillingness to explore ever advancing computer technology, is the loss of increasingly valuable benefits. For example, a computer can help with keeping in touch with friends and family, keeping track of the household budget, providing entertainment for all members of the family, accessing a wide variety of valuable information.

As a further example, the Internet has provided a wealth of information for users to access and explore. The Internet also provides mechanisms for downloading information once the web page containing the desired information is found. However, without a computing device of some sort, this information is not available.

In general, some potential computer owners may be hesitant to invest a relatively large amount of money in a device, such as a computer, which will merely sit on a desk in the house without anyone in the household knowing how to operate the computer. The solution to these problems is to provide a way to familiarize non-computer owners with the operation of a computer and expose them to the utility of ownership without being subjected to being forced to purchase the computer beforehand. Therefore, it would be advantageous to provide a method and system for exposing a potential computer owner to the benefits of owning a computer by charging the potential computer owner for the computer based on actual usage during a trial basis without having to first purchase the computer system.

### SUMMARY OF THE INVENTION

The present invention provides for a method, system and computer program product for charging, by a computer service provider, for a computer system based on usage time. Responsive to receiving a request to utilize the computer system, an operational connection is established between the computer service provider and the computer system. Usage time and periodic charge rate information are received via the operational connection. A charge is then calculated for the usage of the computer system based on results of the usage time and the periodic charge rate.

### DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIG. 4 is an exemplary block diagram illustrating a service provider in accordance with a preferred embodiment of the present invention;

FIG. 5 is an exemplary block diagram illustrating a computer system usage monitor in accordance with a preferred embodiment of the present invention;

FIG. 6 is an exemplary graphical user interface illustrating computer system usage information in accordance with a preferred embodiment of the present invention;

FIG. 7 is an exemplary flowchart illustrating a usage agreement for a computer system in accordance with a preferred embodiment of the present invention; and

FIG. 8 is an exemplary flowchart illustrating establishing a connection between a computer system and a computer system service provider in accordance with a preferred embodiment of the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

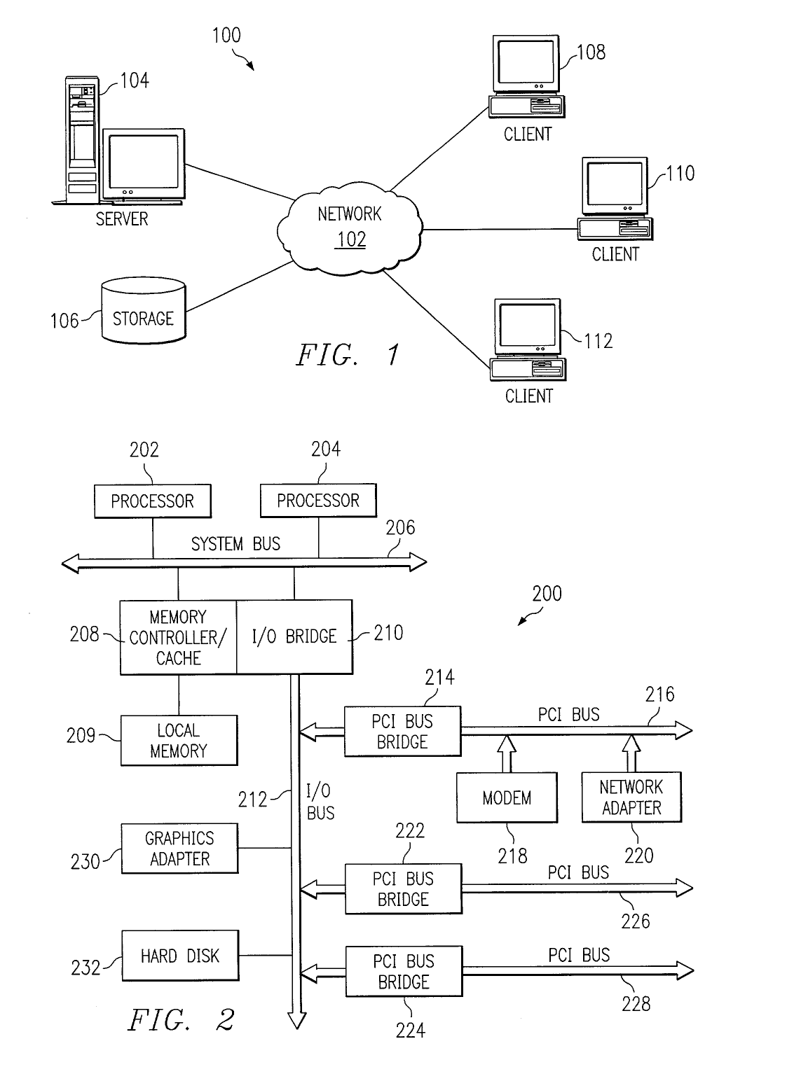

FIG. 2 depicts a block diagram of a data processing system that may be implemented as a server in accordance with a preferred embodiment of the present invention. Data processing system 200 may be a symmetric multiprocessor (SMP) system including a plurality of processors 202 and 204 connected to system bus 206. Alternatively, a single processor system may be employed.

Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, New York, running the Advanced Interactive Executive (AIX) operating system.

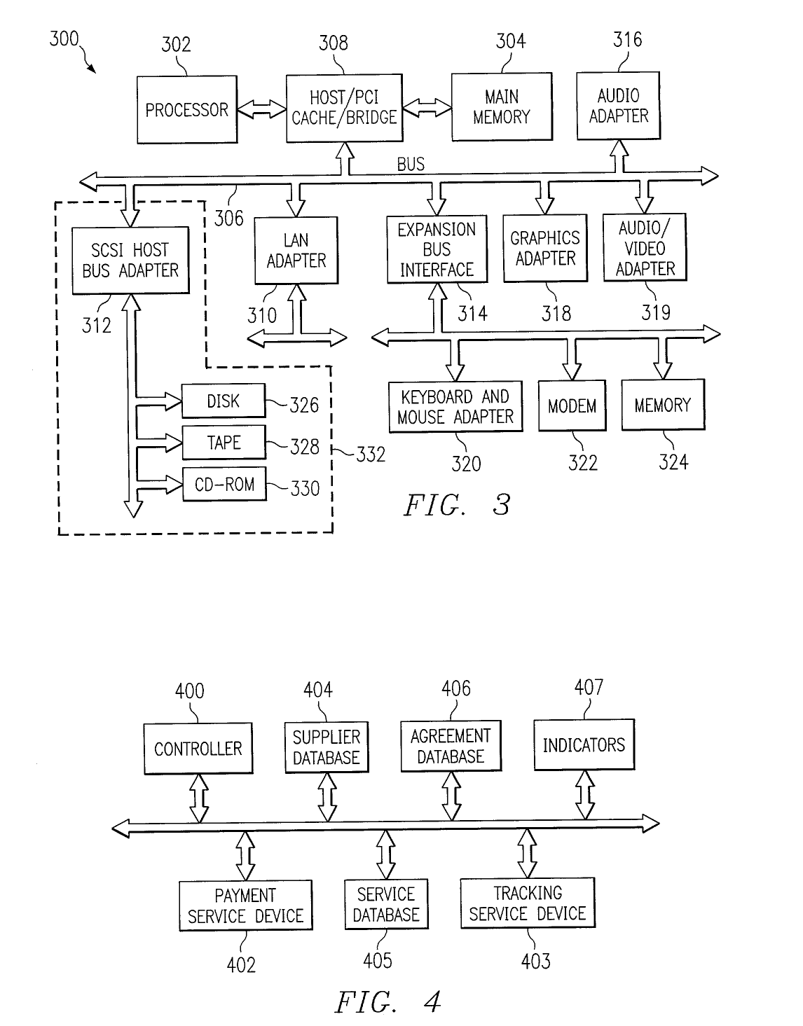

FIG. 3 depicts a block diagram illustrating a data processing system in which the present invention may be implemented. Data processing system 300 is an example of a client computer, such as, for example clients 108, 110 and 112 in FIG. 1. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used.

Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection.

In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a system and method for charging for a computer system based on actual usage time. In one embodiment, an application is associated with the computer system and keeps track of the time the computer system is used. The application sends usage time information to a provider of the computer system, for example, information may be sent to the provider's web server via either a persistent or periodic Internet connection. The usage time information sent to the provider's web server may inform the provider of the amount of time the computer system is used, the amount of time the computer system is idle and the amount of time specific features of the computer system are utilized. For example, the usage time information may inform the provider as to the amount of time the central processing unit is utilized, the amount of time any peripherals connected to the computer system are used and the amount of time that is spent communicating with either other computing systems directly or other computing systems by way of the Internet.

The application may have features which may inform the user of the computer system as to the amount of time used, the amount of time remaining on any block of time which is pre-purchased and any amount of time remaining before a purchase of the computer system is required. The application may also include a variety of optional features which may be intended to appeal to the prospective purchaser of the computer system. For example, there may be a block of time in which use of the computer system is free. Furthermore, there may be incentives built in to use specific computer applications for a fee, on a timed basis. In addition, there may be a reduced charge for exploring the Internet. The computer system may function so that the prospective computer purchaser uses the computer system and the usage time is logged and reported on at least a periodic basis.

Therefore, the prospective computer purchaser gets physical possession of the computer system and is allowed to use the computer system on a timed basis for a period of time. The usage of the computer system by the prospective computer user is “metered”, and the prospective computer user may have to pay for a block of time the computer system is actually used or may have to pay for a block of time the computer system is used after an initial “trial” period in which the use may be free. When the time period elapses, the prospective computer purchaser may purchase additional blocks of time, purchase the computer system outright, or return the computer system to the computer system provider. The return of the computer system may include a web based mechanism in which a return label is generated with or without an associated tracking number to track the return of the computer system.

Furthermore, after elapse of a specified usage time period, an indication may be displayed indicating that the computer system is purchased outright and no further charges will be incurred regarding use of the computer system. The terms of the usage between the computer system provider and the prospective computer purchaser may be negotiable between the two parties with the ultimate goal of the computer system provider to make a sale of the computer system to the prospective computer purchaser.

However, the present invention is not limited to only selling the computer system but also includes leasing computer systems or providing for a lease to buy arrangement in an effort to provide a prospective computer purchaser with a chance to operate the computer system along with the opportunity for the computer system provider to acquaint the prospective computer purchaser with the wide ranging utility of owning the computer system outright.

FIG. 4 is an exemplary block diagram illustrating a service provider in accordance with a preferred embodiment of the present invention. The computer system service provider according to a preferred embodiment of the present invention is implemented in a server on a data network. The computer system service provider includes a controller 400 that controls the various functions of the computer system service provider. The controller 400 is coupled to a tracking service device 403 that has access to a supplier database 404 storing information pertaining to the suppliers of computer system services. The tracking service device 403 also has access to a computer system service database 405 that stores information pertaining to the available computer system services.

The controller 400 is also coupled to an agreement database 406 that stores information pertaining to organizations that have made an agreement with the controller 400 that they will receive payment for providing particular access services on a time period basis. For example, the company that provides a word processing software application may have a contract with the controller 400 that if software application is used for a particular time period, then the company will receive a certain percentage of the proceeds of the transaction for use of the word processing software application.

The controller 400 further has access to indicators 407 that the user accesses through use of the computer system service provider. The indicators 407 identify the character of a certain access by the user. For example, the indicators 407 may include indicators identifying that the access was provided to a user to browse the Internet, to play a particular game of a variety of games either installed on the computer system or accessed through a distributed data processing system, and the like.

The controller 400 is further coupled to a payment service 402. Payment service 402 makes payment to the supplier of the computer system service on the basis of the computer system being used by a user for a certain period of time. For example, after checking the indicator 407 that a computer system was used, the controller 400 checks the agreement database 406 to determine whether the computer system was provided according to an agreement. If so, then the controller 400 makes a payment to the supplier of the computer system service according to the agreement in agreement database 406. Such payment may be performed in any known manner. In a preferred embodiment, such payment is performed by electronic transfer of funds to an account associated with the computer system service provider. The computer system service provider may allow for a trial period in which no charge is made to the user. For example, the computer system service provider may provide for 100 hours of free computer system usage time after which the use of the computer system based on a fee. The fee may be based on, for example, using the computer system on a per minute basis, an hourly basis, and the like.

While the exemplary embodiment shown in FIG. 4 is directed to an embodiment in which all of the blocks 402-407 in FIG. 4 are present in a server of the data network, the invention is not limited to such an architecture. Rather one or more of the blocks 402-407 may be distributed amongst a plurality of devices in the data network. For example, a first server may have devices 403-407 while a second server may have payment service 402. Moreover, one or more of the devices 401-407 may be resident in an agent on the user's client device. For example, payment service 402 may be implemented as software on a client, such as, for example, client 300 in FIG. 3.

In operation, the computer system service provider receives a request from a user's client device to use the computer system. The request includes, for example, an identifier of the user or user's client device. This information may be provided in data packet headers, for example, of the request. Based on the user identifier, the controller 400 may identify the user and the user's client device as well as the computer system services tool that have been agreed to be provided. Such a determination may be made by looking-up the user in a registered user directory associated with the controller 400, for example.

Once a user's session with the computer system service provider is complete, payment service 402 checks the indicators 407 to determine which computer system services were provided to the user, who the suppliers of those computer system services are, and the like. The payment service 402 may then search the computer system service and/or the supplier of the computer system service in the agreement database 406 to determine if an agreement has been established with the supplier of the computer system service regarding a royalty to be paid to the supplier. If so, the payment service 402 makes payment to an account of the supplier in accordance with the agreement terms.

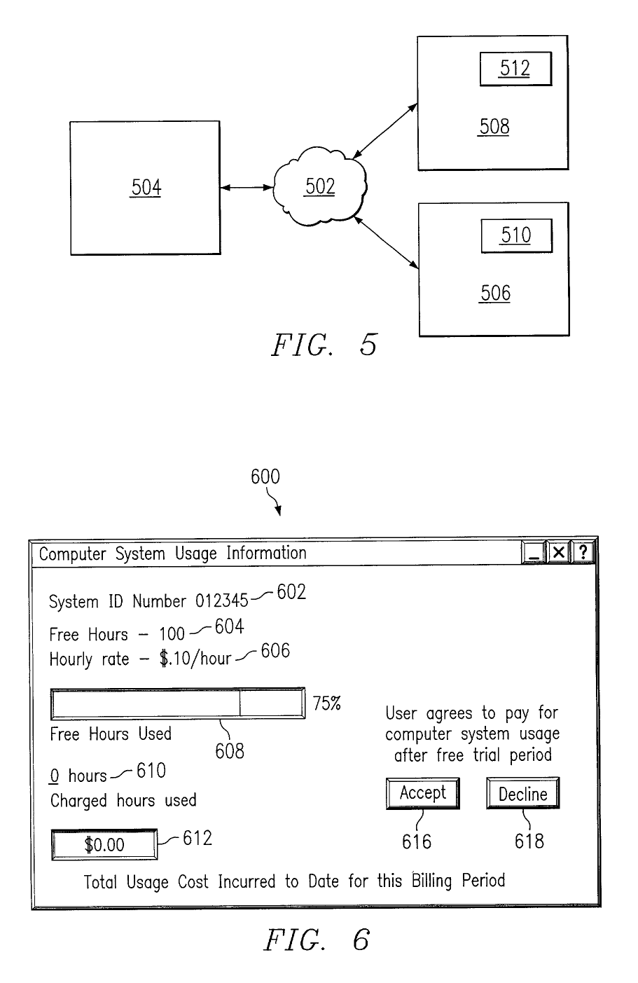

FIG. 5 is an exemplary block diagram illustrating a computer system usage monitor in accordance with a preferred embodiment of the present invention. As stated above, the present invention monitors the usage of a computer system by a user. The user may use the computer system at will, however, may be charged a fee for the use of the computer. In addition, the computer user may be allowed a free trial period, for example, 100 hours, in which to get acquainted and learn the computer system. Any use of the computer system past this free trial period may be tracked and the user may be charged a fee for all additional time the computer system is used after the free trial period has run. The user may be charged for using the computer system based on a periodic usage period and this periodic usage period may be, for example, by the minute, the half-hour, the hour, and the like.

In this example, distributed data processing system 502, such as, for example, the Internet may be the avenue in which client computer systems 506 and 508 may access a server, such as, for example, server 504. At each client computer system 506 and 508 may be a usage monitoring software 510 and 512, respectively. Monitoring software 510 may monitor the details on the usage of computer system 506 and monitoring software 512 may monitor the details on the usage of computer system 508. Alternatively, monitoring software 510 may monitor the details of the usage of both computer systems 506 and 508. Usage monitoring software 510 and 512 may be installed on client computer systems 506 and 508 or may be installed remote from client computer systems 506 and 508.

Once computer systems 506 and 508 are powered up, monitoring software 510 and 512 record usage data of computer systems 506 and 508. Monitoring software 510 and 512 may transmit data regarding the use of computer systems 506 and 508 on a periodic basis during the use of the computer systems. Alternatively, monitoring software 510 and 512 may transmit data regarding the user of computer systems 506 and 508 at the end of a computer session. Regardless of whether the details of the usage of computer systems 506 and 508 are periodic or at the end of a session, the data is transmitted to server 504 via distributed data processing system 502. Server 504 then logs the usage of computer systems 506 and 508, determines the amount of free trial period time, if any, that is applicable for computer systems 506 and 508 and calculates the charges to be applied to computer systems 506 and 508. A statement regarding usage and the charges for the usage of computer systems 506 and 508 may then be sent to the user or person who has agreed to pay for such usage on a time basis. A statement of usage charges may also be displayed each time the user accesses computer system 506 and 508. For example, a running account of usage charges may be displayed once either computer system 506 or 508 is powered up and once again when the user sends a command for computer system 506 or 508 to log off.

FIG. 6 is an exemplary graphical user interface illustrating computer system usage information in accordance with a preferred embodiment of the present invention. When a service between a computer system and a computer system service provider is set up based on usage time of the computer system, a user may agree to be bound by an agreement in which the computer system service is provided. The agreement may contain, for example, an amount of trial hours in which the computer system service provider may allow the user to use the computer system for free, the hourly rate the user may have to pay for any usage of the computer system above the free trial period and whether or not the user agrees to use the computer system past the free trial period. A graphical user interface (GUI) may be used to convey this information as well as information regarding the hours that have been used to the user.

In this example, computer system usage information GUI 600 may contain computer system identification number 602. In addition, the amount of free hours, if any, provided by the agreement between the computer system user and the computer system service provider may be indicated in computer system usage information GUI 600. In this example, free hours field 604 indicate that 100 free hours are allowed to be used before any charges are incurred by the user. When the hours indicated in free hours field 604 are consumed as indicated by free hours used indicator 608, hourly rate field 606 has the charge for which the user will incur for any use past the free trial period. In this example free hours used indicator 608 shows indicates that 75% or 75 hours have been used thus far by the user and no charges have been incurred by the user. Charged hours used indicator 610 indicates the amount of time the computer system has been used. The charge per hour shown in hourly rate field 606 multiplied by the amount of time shown in charged hours indicator 610 result in the charged reflected in total cost incurred to date for this billing period field 612.

Upon completion of the free trial period, if any, provided for by the agreement between the user of the computer system and the computer system service provider, the user may be asked to agree to further usage of the computer system on a timed basis. Therefore, upon the elapse of the free trial period or upon nearing the end of the free trial period, computer system usage information GUI 600 may require the user of the computer system to once again agree to continued usage after the free trial period elapses. Upon the termination of the free trail period or upon nearing the end of the free trial period, the user may be required to agree to pay for computer system usage after the free trial period by selecting agree virtual button 616 or decline to pay for computer system usage after the free trail period by selecting decline virtual button 618.

Upon the selection of accept virtual button 616, computer system usage information GUI reports the hours the user is charged for using the computer system and the total usage cost during a billing period. Upon the selection of decline virtual button 618, the computer system service provider may terminate service to the computer system and deny access to any further attempts to use the computer system.

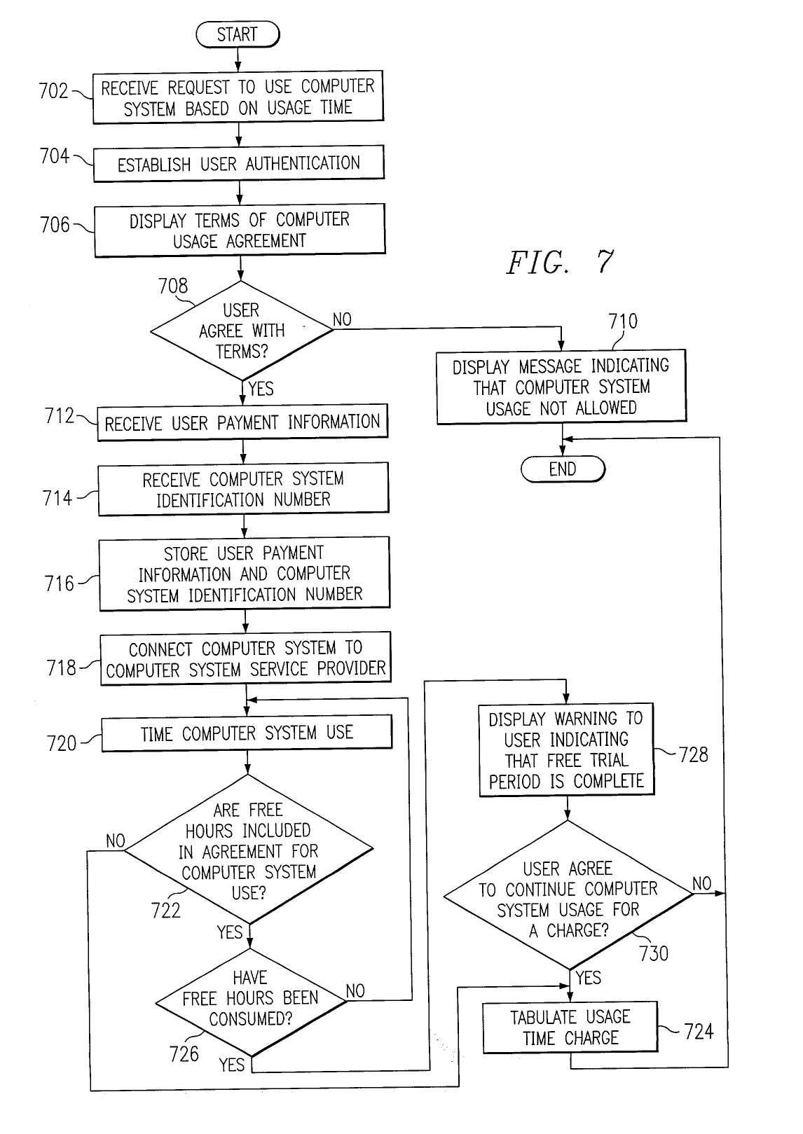

FIG. 7 is an exemplary flowchart illustrating a usage agreement for a computer system in accordance with a preferred embodiment of the present invention. In this example, the operation starts by receiving a request to use a computer system based on usage time (step 702). User authentication is then established (step 704). User authentication may be established by the user providing, for example, a user name and a password. Terms of the computer system usage agreement are then displayed (step 706). Then a determination is made as to whether or not the user agrees with the terms of the computer system usage agreement (step 708). If the user does not agree with the terms of the computer system usage agreement (step 706:NO), a message is displayed indicating that computer system usage is not allowed (step 710), and thereafter the operation terminates. If the user does agree with the terms of the computer system usage agreement (step 708:YES), user payment information is received (step 712). A computer system identification number is received in which the user is matched to the computer system (step 714). The user payment information and the computer system identification number are then stored (716). The computer system is then connected to the computer system service provider (step 718). Monitoring of the time the computer system is used is then initiated (step 720).

Then a determination is made as to whether or not there are free hours included in the agreement to use the computer system (step 722). If there are not free hours included in the agreement to use the computer system (step 722:NO), usage time charges are tabulated for using the computer system (step 724), and thereafter the operation terminates. If there are free hours included in the agreement to use the computer system (step 722:YES), then a determination is made as to whether or not the free hours have been consumed (step 726). If the free hours have not been consumed (step 726:NO), the operation returns to step 720 in which the computer system use is timed. If the free hours have been consumed (step 726:YES), then a warning is displayed indicating that the free trial period is complete (step 728). Then a determination is made as to whether or not the user has agreed to continue the computer system usage for a charge (step 730). If the user does not agree to continue the computer system usage for a charge (step 730:NO), the operation terminates. If the user does agree to continue the computer system usage for a charge (step 730:YES), then usage time charges are tabulated (step 724), and thereafter the operation terminates.

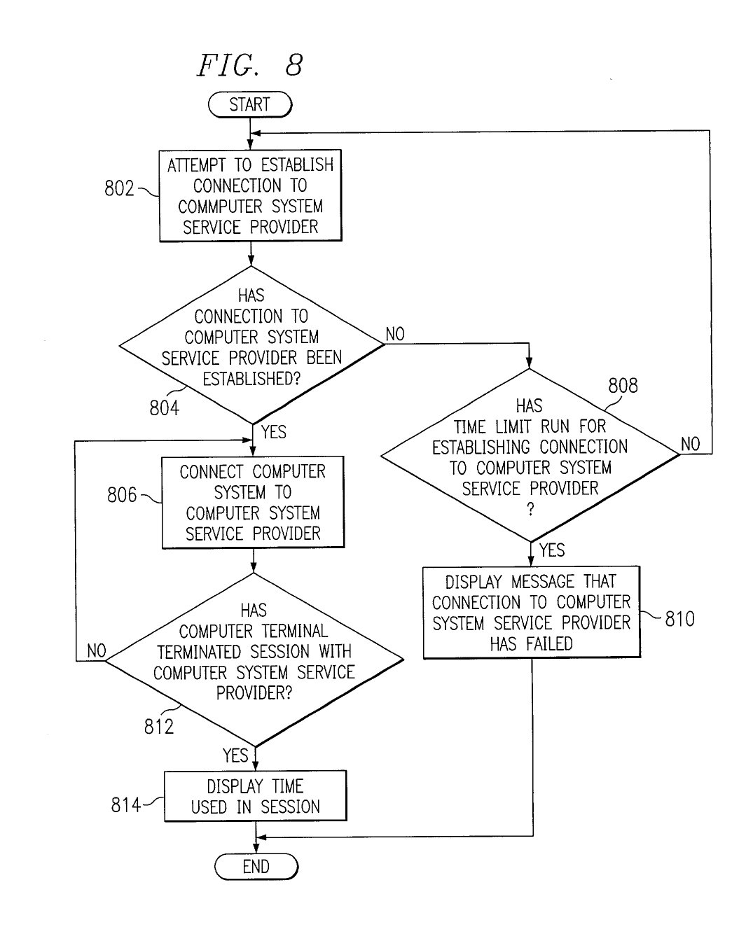

FIG. 8 is an exemplary flowchart illustrating establishing a connection between a computer system and a computer system service provider in accordance with a preferred embodiment of the present invention. In this example, the operation starts by attempting to establish a connection between the computer system and the computer system service provider (step 802). Then a determination is made as to whether or not a connection between the computer system and the computer system service provider has been established (step 804). If a connection between the computer system and the computer system service provider has not been established (step 804:NO), then a determination is made as to whether or not a time limit has run for establishing a connection between the computer system and the computer system service provider (step 808). If the time limit has not run for establishing a connection between the computer system and the computer system service provider (step 808:NO), the operation returns to step 802 in which an attempt is made to establish a connection between the computer system and the computer system service provider. If a time limit has run for establishing a connection between the computer system and computer system service provider (step 808:YES), a message is displayed indicating that the connection between the computer system and the computer system service provider has failed (step 810), and thereafter the operation terminates.

Returning to step 804, if there is a determination that a connection between the computer system and the computer system service provider has been established (step 804:YES), the computer system is connected to the computer system service provider (step 806). A determination is then made as to whether or not the computer system has terminated a session with the computer system service provider (step 812). If the computer system has not terminated the session between the computer system and the computer system service provider (step 812:NO), the operation returns to step 806 in which the computer system is connected to the computer system service provider. If the computer system has terminated the session between the computer system and the computer system service provider (step 812), the time used in the session are displayed (step 814), and thereafter the operation terminates.

Therefore, the present invention provides a mechanism for exposing a potential computer owner to the benefits of owning a computer by charging the potential computer owner for the computer based on actual usage during a trial basis without having to first purchase the computer system. The charges for using the computer system are based on actual usage of the computer system. A computer system service provider keeps track of the time the computer system is used. A user of the computer system may be charged on, for example, an hourly basis for use of the computer system. This mechanism has the ability to increase sales of computer systems by exposing a non-computer owner to the benefits of using a system without expending a great deal of money. In fact, a user of a computer system may get accustomed to using the system and may not want to return the system when a trial usage period terminates. In addition, the computer system user may not want to return the computer system because after a period of use, there may be a large amount of data stored on the computer system in which the user may not want to go to the trouble of storing on, for example, floppy disks. In either case, the user of the computer system may want to purchase the computer system outright. Therefore, the present invention provides an opportunity for someone to become accustomed to the operation and gain familiarity with a computer system while promoting and eventually increasing sales of computer systems to those who would otherwise not consider such a purchase.

Furthermore, it is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of charging, by a computer service provider, for a computer system based on usage time, the method comprising the steps of:
responsive to receiving a request to utilize the computer system, establishing an operational connection between the computer service provider and the computer system;
receiving monitored usage time and periodic charge rate information via the operational connection; and
calculating a charge for the usage of the computer system based on the usage time and the periodic charge rate.

2. The method as recited in claim 1, wherein the operational connection allows the computer system to operate in a functional manner.

3. The method as recited in claim 1, further comprising:
transmitting the charge for the usage of the computer system; and
displaying the charge for the usage of the computer system on the computer system.

4. The method as recited in claim 1, further comprising:
establishing a predetermined time period in which the usage of the computer system is not charged; and
calculating the charge for the usage of the computer system based on results of the usage time and periodic charge rate minus the predetermined time period in which usage of the computer system is not charged.

5. The method as recited in claim 4, wherein the predetermined time period in which the usage of the computer system is not charged is prior to applying the periodic charge rate to the usage time.

6. The method as recited in claim 4, further comprising:
displaying an indication that the predetermined time period has elapsed; and
in response to receiving an input indicating that continued usage of the computer system is not elected, terminating the operational connection between the computer service provider and the computer system.

7. The method as recited in claim 1, wherein charging, by a computer service provider, for a computer system based on usage time is based on a predetermined agreement between the computer system service provider and a user of the computer system.

8. The method as recited in claim 1, wherein receiving usage time and periodic charge rate information via the operational connection, further comprises:
receiving the usage time on a periodic basis; and
terminating the operational connection between the computer service provider and the computer system if the usage time is not transmitted after a predetermined period of time.

9. The method as recited in claim 1, wherein the computer system service provider is located on a server.

10. The method as recited in claim 1, wherein the computer system is located at a client machine.

11. The method as recited in claim 1, wherein information regarding the usage of the computer system includes at least one of a computer system identifier, the periodic charge rate, number of hours used, and total cost incurred for using the computer system.

12. The method as recited in claim 11, wherein the information regarding the usage of the computer system is displayed in a graphical user interface.

13. The method as recited in claim 11, wherein the number of hours used includes an indication of at least one of a predetermined time period in which usage of the computer system is not charged and charged usage time of the computer system.

14. The method as recited in claim 11, wherein after elapse of a specified usage time period, indicating that the computer system is purchased outright and no further charges will be incurred regarding use of the computer system.

15. The method as recited in claim 1, wherein monitoring usage time and periodic charge rate information for the computer system via the operational connection is monitored by a monitoring software application.

16. The method as recited in claim 15, wherein the monitoring software application is installed remote from the computer system.

17. A system, comprising:
a bus system;
a communications unit connected to the bus system;
a memory connected to the bus system, wherein the memory includes a set of instructions; and
a processing unit connected to the bus system, wherein, responsive to receiving a request to utilize the computer system, the processing unit executes the set of instructions from the memory to instruct the communication unit to establish an operational connection between the computer service provider and the computer system, the processing unit receives usage time and periodic charge rate information via the operational connection, and the processing unit calculates a charge for the usage of the computer system based on results of the usage time and the periodic charge rate.

18. A system for charging, by a computer service provider, for a computer system based on usage time, comprising:
a connection mechanism, responsive to receiving a request to utilize the computer system, for establishing an operational connection between the computer service provider and the computer system;
a receiver for receiving monitored usage time and periodic charge rate information via the operational connection; and
a calculator for calculating a charge for the usage of the computer system based on the usage time and the periodic charge rate.

19. A data processing system charging, by a computer service provider, for a computer system based on usage time, the method comprising the steps of:
establishing means, responsive to receiving a request to utilize the computer system, for establishing an operational connection between the computer service provider and the computer system;
receiving means for receiving monitored usage time and periodic charge rate information via the operational connection; and
calculating means for calculating a charge for the usage of the computer system based on the usage time and the periodic charge rate.

20. The data processing system as recited in claim 19, further comprising:
transmitting means for transmitting the charge for the usage of the computer system; and
displaying means for displaying the charge for the usage of the computer system on the computer system.

21. The method as recited in claim 19, further comprising:
establishing means for establishing a predetermined time period in which the usage of the computer system is not charged; and
calculating means for calculating the charge for the usage of the computer system based on results of the usage time and periodic charge rate minus the predetermined time period in which usage of the computer system is not charged.

22. The method as recited in claim 21, further comprising:
displaying means for displaying an indication that the predetermined time period has elapsed; and
terminating means, in response to receiving an input indicating that continued usage of the computer system is not elected, for terminating the operational connection between the computer service provider and the computer system.

23. The method as recited in claim 19, wherein receiving usage time and periodic charge rate information via the operational connection, further comprises:
receiving means for receiving the usage time on a periodic basis; and
terminating means for terminating the operational connection between the computer service provider and the computer system if the usage time is not transmitted after a predetermined period of time.

24. A computer program product in a computer readable medium for charging, by a computer service provider, for a computer system based on usage time, comprising:
instructions, responsive to receiving a request to utilize the computer system, for establishing an operational connection between the computer service provider and the computer system;
instructions for receiving monitored usage time and periodic charge rate information via the operational connection; and
instructions for calculating a charge for the usage of the computer system based on the usage time and the periodic charge rate.

25. The computer program product as recited in claim 24, wherein the operational connection allows the computer system to operate in a functional manner.

26. The computer program product as recited in claim 24, further comprising:
instructions for transmitting the charge for the usage of the computer system; and
instructions for displaying the charge for the usage of the computer system on the computer system.

27. The computer program product as recited in claim 24, further comprising:
instructions for establishing a predetermined time period in which the usage of the computer system is not charged; and
instructions for calculating the charge for the usage of the computer system based on results of the usage time and periodic charge rate minus the predetermined time period in which usage of the computer system is not charged.

28. The computer program product as recited in claim 27, wherein the predetermined time period in which the usage of the computer system is not charged is prior to applying the periodic charge rate to the usage time.

29. The computer program product as recited in claim 27, further comprising:
instructions for displaying an indication that the predetermined time period has elapsed; and
instructions, in response to receiving an input indicating that continued usage of the computer system is not elected, for terminating the operational connection between the computer service provider and the computer system.

30. The computer program product as recited in claim 24, wherein charging, by a computer service provider, for a computer system based on usage time is based on a predetermined agreement between the computer system service provider and a user of the computer system.

31. The computer program product as recited in claim 24, wherein receiving usage time and periodic charge rate information via the operational connection, further comprises:
instructions for receiving the usage time on a periodic basis; and
instructions for terminating the operational connection between the computer service provider and the computer system if the usage time is not transmitted after a predetermined period of time.

32. The computer program product as recited in claim 24, wherein the computer system service provider is located on a server.

33. The computer program product as recited in claim 24, wherein the computer system is located at a client machine.

34. The computer program product as recited in claim 24, wherein information regarding the usage of the computer system includes at least one of a computer system identifier, the periodic charge rate, number of hours used, and total cost incurred for using the computer system.

35. The computer program product as recited in claim 34, wherein the information regarding the usage of the computer system is displayed in a graphical user interface.

36. The computer program product as recited in claim 34, wherein the number of hours used includes an indication of at least one of a predetermined time period in which usage of the computer system is not charged and charged usage time of the computer system.

37. The computer program product as recited in claim 34, wherein after elapse of a specified usage time period, indicating that the computer system is purchased outright and no further charges will be incurred regarding use of the computer system.

38. The computer program product as recited in claim 24, wherein monitoring usage time and periodic charge rate information for the computer system via the operational connection is monitored by a monitoring software application.

39. The computer program product as recited in claim 38, wherein the monitoring software application is installed remote from the computer system.
